(19) United States
(12) Patent Application Publication
(10) Pub. No.: US 2005/0012599 A1
(43) Pub. Date: Jan. 20, 2005

(54) Reconfigurable vehicle display

(76) Inventor: Bryan N. DeMatteo, Forest Hills, NY (US)

Correspondence Address: BRYAN N. DEMATTEO, 68-12 YELLOWSTONE BLVD., APT. 2W, FOREST HILLS, NY, 11375, US

(21) Appl. No.: 10/621,546

(22) Filed: Jul. 17, 2003

(51) Int. Cl. B60Q 1/00

(52) U.S. Cl. 340/425.5; 340/815.4; 340/691.6

(57) ABSTRACT

A reconfigurable display of a vehicle is provided. The display includes an input arrangement to receive configuration information from at least one user; a processing arrangement electrically and communicatively coupled to the input arrangement to process the configuration information; and a display arrangement electrically and communicatively coupled to the processing arrangement. The processing arrangement is configured to cause the display arrangement to display at least one characteristic of the vehicle in accordance with profile information assigned to a selected profile of a plurality of profiles.

### FIELD OF THE INVENTION

The present invention relates to display arrangements, for example, display arrangements for automobiles.

### BACKGROUND INFORMATION

It is known to provide reconfigurable display arrangements for vehicles, for example, automobiles. For example, Cadillac introduced its Vizon concept car at the Detroit Auto Show in 2001. The Vizon features a reconfigurable display, which permits the driver to choose how and where data concerning the car is displayed. However, it is believed that reconfigurable vehicle displays, such as the Vizon display, only permit the automobile display to be reconfigured into a single configuration. Accordingly, if more than one person uses the automobile, such as various members of a family (e.g., mother, father, son, etc.), the display may need to be reconfigured each time a different person uses the automobile. In this manner, it is believed that prior art reconfigurable displays permit no intra group customability.

Furthermore, it is believed that prior art reconfigurable automobile displays only permit one display mode for a given configuration of the display. Thus, it is believed that conventional reconfigurable displays do not adapt to particular operating states of the vehicle and/or the occurrence of particular events.

### SUMMARY OF THE INVENTION

It is an object of the present invention to reconfigurable display arrangement of a vehicle that overcomes the disadvantages described above. More specifically, it is an object of the present invention to provide a novel reconfigurable display that permits intra-group customability (e.g., individual customability for the members of a defined group). For this purpose, the present invention provides a novel reconfigurable display arrangement of a vehicle including an input arrangement to receive configuration information from at least one user; a processing arrangement electrically and communicatively coupled to the input arrangement to process the configuration information; and a display arrangement electrically and communicatively coupled to the processing arrangement; in which the processing arrangement is configured to cause the display arrangement to display at least one characteristic of the vehicle in accordance with information assigned to a selected profile of a plurality of profiles.

It is another object of the present invention to provide the display arrangement described above, in which the display arrangement includes at least one of a liquid crystal display, a heads-up display projected onto a windshield of the vehicle, an organic electroluminance display, a picture tube, a computer monitor, and a television.

It is still another object of the present invention to provide the display arrangement described above, in which the processing arrangement includes a microprocessor to receive the configuration information from the input arrangement, a memory arrangement to store a software program to be executed on the microprocessor, and a display driver electrically and communicatively coupled to the microprocessor and configured to format display information generated by microprocessor so that the display information may be suitably displayed on the display arrangement.

It is yet another object of the present invention to provide the display arrangement described above, in which the microprocessor receives electronic signals from associated vehicle sensors characterizing associated displayable vehicle characteristics, the processing arrangement being configured to cause the display arrangement to display the at least one characteristic of the vehicle in accordance with the electronic signals.

It is still another object of the present invention to provide the display arrangement described above, in which the electronic signals include at least one of a signal characterizing a speed of the vehicle, a signal characterizing revolutions per minute (RPM) of an engine, a signal characterizing a temperature of the engine, a signal characterizing a temperature of ambient air inside a driving compartment, a signal characterizing a temperature of air outside the vehicle, a signal characterizing humidity, a signal characterizing oil pressure, a signal characterizing a gasoline level, a signal characterizing a turn directional, a signal characterizing radio station information, a signal characterizing cruise control information, a signal characterizing headlight status information, and a signal characterizing an electronic map in relation to a geographical position of the vehicle.

It is yet another object of the present invention to provide the display arrangement described above, in which the selected profile of the plurality of profiles is selected automatically.

It is still another object of the present invention to provide the display arrangement described above, in which the selected profile of the plurality of profiles is selected when the user selects a custom preset for at least one vehicle characteristic.

It is yet another object of the present invention to provide the display arrangement described above, in which the custom preset for at least one vehicle characteristic includes at least one of a custom preset of a seat adjustment, a custom preset of an air conditioning preference, a custom preset of a music station preference, a custom preset of a music volume preference, and a custom preset of a cabin lighting intensity preference.

It is still another object of the present invention to provide the display arrangement described above, in which the selected profile of the plurality of profiles is selected by detecting the presence of at least one transponder.

It is yet another object of the present invention to provide the display arrangement described above, in which the at least one transponder includes one of an inductively coupled passive transponder and an active transponder.

It is still another object of the present invention to provide the display arrangement described above, in which the profile information includes information related to a particular user preference of what data concerning the vehicle is to be displayed to the user via the display arrangement 210, and the profile information includes information related to a particular user preference of how and where the data concerning the vehicle is to be displayed.

It is yet another object of the present invention to provide the display arrangement described above, in which the data concerning the vehicle includes at least one of speed of the vehicle, revolutions per minute (RPM) of an engine, temperature of the engine, temperature of ambient air inside a driving compartment, temperature of air outside the vehicle, humidity information, oil pressure, gasoline level, turn directional, radio station information, cruise control information, headlight status, and an electronic map in relation to a geographical position of the vehicle.

It is still another object of the present invention to provide the display arrangement described above, in which the processing arrangement permits at least one of the plurality of profiles to be edited by the user.

It is yet another object of the present invention to provide the display arrangement described above, in which the processing arrangement may be caused to enter a profile management mode to permit at least one authorized user to at least one of add profiles, to delete profiles, and to change access permissions of the profiles.

It is still another object of the present invention to provide the display arrangement described above, in which the at least one characteristic of the vehicle is displayed in accordance with an operating state of the vehicle.

It is yet another object of the present invention to provide the display arrangement described above, in which each of the profiles includes a plurality of sub-profiles, each of the sub-profiles being assigned to a respective operating state of the vehicle, the at least one characteristic of the vehicle being displayed in accordance with information assigned to a sub-profile assigned to a current operating state of the vehicle.

It is still another object of the present invention to provide the display arrangement described above, in which the at least one characteristic of the vehicle is displayed in accordance with an occurrence of an event.

It is yet another object of the present invention to provide the display arrangement described above, in which the event includes at least one of a particular time, a particular duration of time, a particular month, and a particular season.

### BRIEF DESCRIPTION OF THE DRAWINGS

FIG. 1 shows a first exemplary reconfigurable vehicle display arrangement according to the present invention.

FIG. 2 shows a first exemplary processing arrangement of the reconfigurable vehicle display arrangement of FIG. 1, according to the present invention.

FIG. 3 illustrates an exemplary electronic video and/or picture display information displayed on the display arrangement of FIG. 1.

FIG. 4 is a block diagram showing an operational sequence of the functionality of software code configured to be executed by microprocessor of the processing arrangement of FIG. 1.

FIG. 5 is a diagram showing a profile select mode according to the present invention.

FIG. 6 illustrates the interior of a vehicle having a weight sensor configured to communicate a weight signal to an exemplary reconfigurable display arrangement according to the present invention.

FIG. 7 illustrates three hypothetical display formats in the form of speed indicators for display the speed of a vehicle.

### DETAILED DESCRIPTION

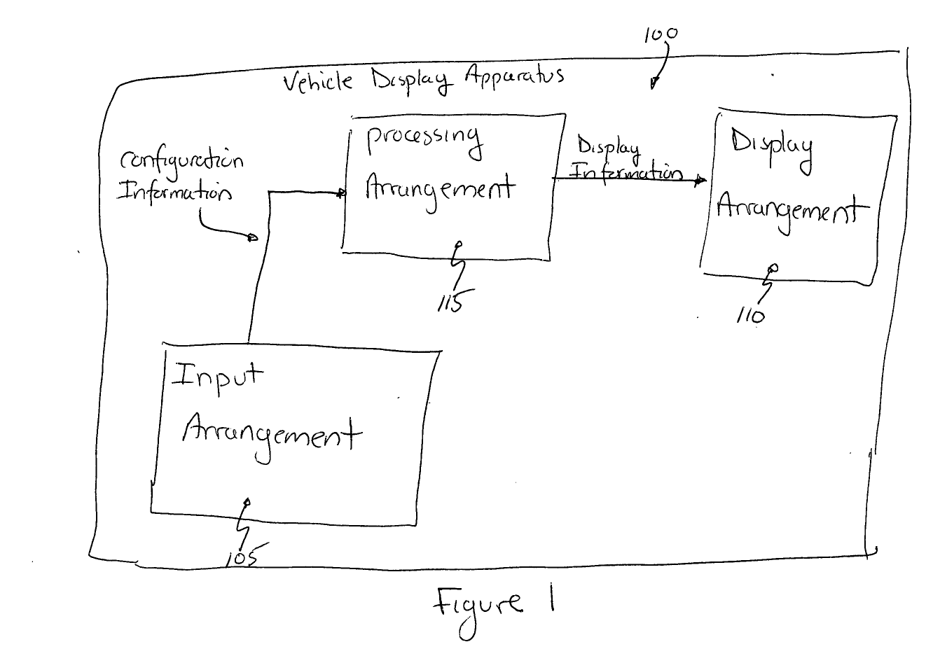

Referring now to FIG. 1, there is seen a first exemplary reconfigurable vehicle display 100 according to the present invention. Reconfigurable vehicle display 100 includes an input arrangement 105 to receive configuration information from a user, for example, a driver of a vehicle, a processing arrangement 115 electrically and communicatively coupled to input arrangement 105 to process the configuration information entered by the user into the input arrangement 105, and a display arrangement 110 electrically and communicatively coupled to processing arrangement 105 to display at least one characteristic of the vehicle. It should be appreciated that reconfigurable vehicle display 100 may be used in any type of vehicle, such as an automobile, boat, plane, tractor, jet-ski, etc.

Input arrangement 105 may include any conventional arrangement operable to receive informational input from a user for reconfiguring reconfigurable vehicle display 100. For this purpose, input arrangement 105 may include, for example, a keyboard, a touch pad, a microphone (e.g., for voice commands—voice recognition), a mouse, an electronic pointer, a touch screen (e.g., the display arrangement 210 itself may also be used as an input arrangement for inputting configuration data) and/or any other conventional prior art input arrangement. In a known manner, input arrangement 105 is configured to communicate the inputted user information as configuration information to processing arrangement 115 for selecting, editing and managing, for example, a display profile, as more fully described below.

Processing arrangement 115 includes circuitry, software, hardware, etc. operable to process the configuration information communicated by input arrangement 105. In accordance with the configuration information, the processing arrangement 115 generates electronic video and/or picture display information formatted for display to the user via display arrangement 110, the display information representing at least one characteristic of the vehicle. The manner in which processing arrangement 115 generates the display is more fully described below.

Display arrangement 110 may include any conventional arrangement operable for displaying the electronic video and/or picture display information to the user. For example, display arrangement 110 may include a liquid crystal display arrangement (LCD), a heads-up display projected onto the windshield of the vehicle, an organic electroluminance display, a picture tube, a computer monitor, a television, and/or any other display apparatus. As described above, the display information represents at least one characteristic of the vehicle. The characteristics of the vehicle (i.e., vehicle characteristics) are specifically defined herein to include any displayable characteristic of the vehicle or the vehicle's environment. For example, the vehicle characteristic(s) may include the speed of the vehicle, revolutions per minute (RPM) of the engine, temperature of the engine, temperature of the ambient air inside the driving compartment, temperature of the air outside the vehicle, humidity information, oil pressure, gasoline level, turn directional, radio station information (e.g., station, volume, etc.), cruise control information (e.g., set, resume, etc.), headlight status information (e.g., lights off, normal, high-beams), an electronic map in relation to the geographical position of the vehicle, etc.

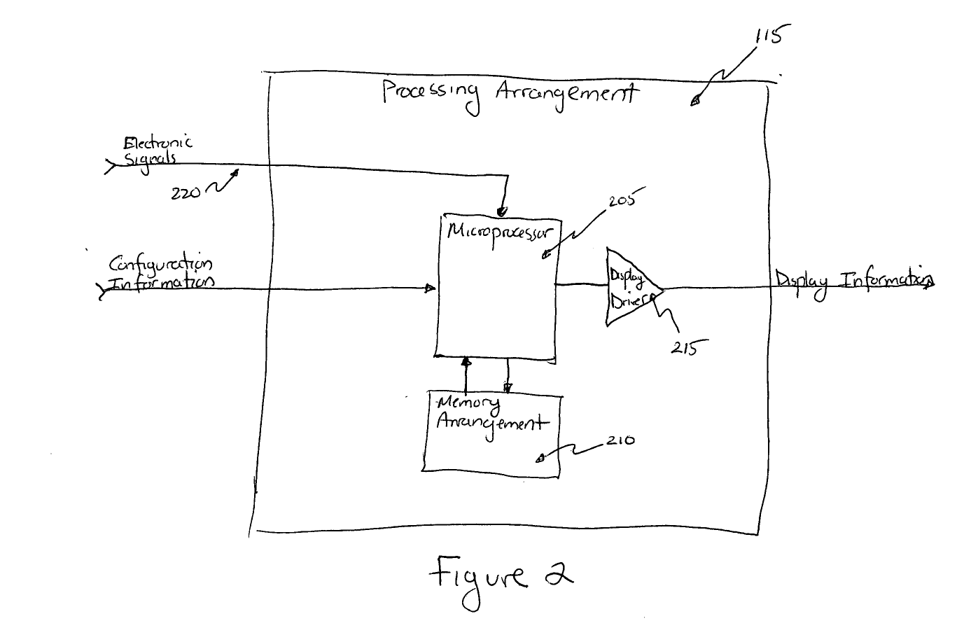

Referring now to FIG. 2, there is seen a first exemplary processing arrangement 115 according to the present invention. Processing arrangement 115 includes a microprocessor 205 to receive the configuration information from input arrangement 105, a memory arrangement 210 to store a software program to be executed on microprocessor 205, and a display driver 215 electrically and communicatively coupled to the microprocessor 205 and configured to format the display information generated by microprocessor 205 so that the display information may be suitably displayed on display arrangement 110.

Microprocessor 205 is configured to execute a software program stored in memory arrangement 210 for displaying the electronic video and/or picture display information (e.g., the at least one displayable vehicle and/or environmental characteristic) to the user in accordance with the configuration information received from input arrangement 105. For this purpose, microprocessor 205 receives electronic signals 220, which include signals from associated vehicle sensors (not shown), which produce the signals in accordance with associated displayable vehicle characteristics. For example, electronic signals 220 may include signals received from sensors (not shown) for measuring the speed of the vehicle, revolutions per minute (RPM) of the engine, temperature of the engine, temperature of the ambient air inside the driving compartment, temperature of the air outside the vehicle, humidity information, oil pressure, gasoline level, turn directional, radio station information (e.g., station, volume, etc.), cruise control information (e.g., set, resume, etc.), headlight status information (e.g., lights off, normal, high-beams), an electronic map in relation to the geographical position of the vehicle, and/or any other measurable characteristic of the vehicle or the vehicle's environment. It should also be appreciated that electronic signals 220 may include signals generated from other arrangements not associated with vehicle characteristics or the vehicle's environment. For example, electronic signals 220 may include signals generated from a Global Positioning Satellite (GPS) locator (e.g., to display the geographical position of the vehicle on an electronically generated map or the like), satellite radio, DVD player, video phone, etc.

Memory arrangement 210 may include any memory storage device for storing digital information. For example, memory arrangement 210 may include a flash memory, a random access memory, a ROM memory, recordable media (e.g., CD, minidisk, etc.), a memory stick, and/or hard drive. According to the present invention, memory arrangement 210 stores software code configured to be executed by microprocessor 205 for displaying the electronic video and/or picture display information to the user in accordance with the configuration information received from the input arrangement 105. Memory arrangement 210 may also store profile information and display mode information, as more fully described below. It should be appreciated that memory arrangement 210 may be physically located anywhere in the vehicle, and need not be part of processing arrangement 115. For example, memory arrangement 210 may reside in a control circuit for controlling one or more functions of the vehicle.

In another exemplary embodiment of the present invention, the processing arrangement 115 includes a data interface arrangement (not shown) configured to retrieve update information from an external computer (not shown), the data interface arrangement configured to retrieve the update information either wirelessly from the computer or via a cable connected to the computer, the update information configured to update the software program stored in memory. The update information may be downloaded via an update cable (not shown) connected to the computer, for example, a computer at the user's home or at a vehicle service station or center. Alternatively, the update information may be downloaded wirelessly, for example, from a local area network, a wide area network, the Internet, the wireless web, etc. The technology to effect such updating of display formats, i.e., the technology for downloading information wirelessly and/or via a cable is widely known and, as such, will not be given further attention.

It should be appreciated that, although the novel features of the present invention are effected by the execution of a software program on microprocessor 205 of processing arrangement 115, other structures, circuits, methods, etc. may be employed to process the configuration information communicated by input arrangement 105. For example, the functions of the software program may be implemented entirely in hardware, thereby obviating the need for the software program. Or, for example, only some of the functionality of the software may be implemented in hardware.

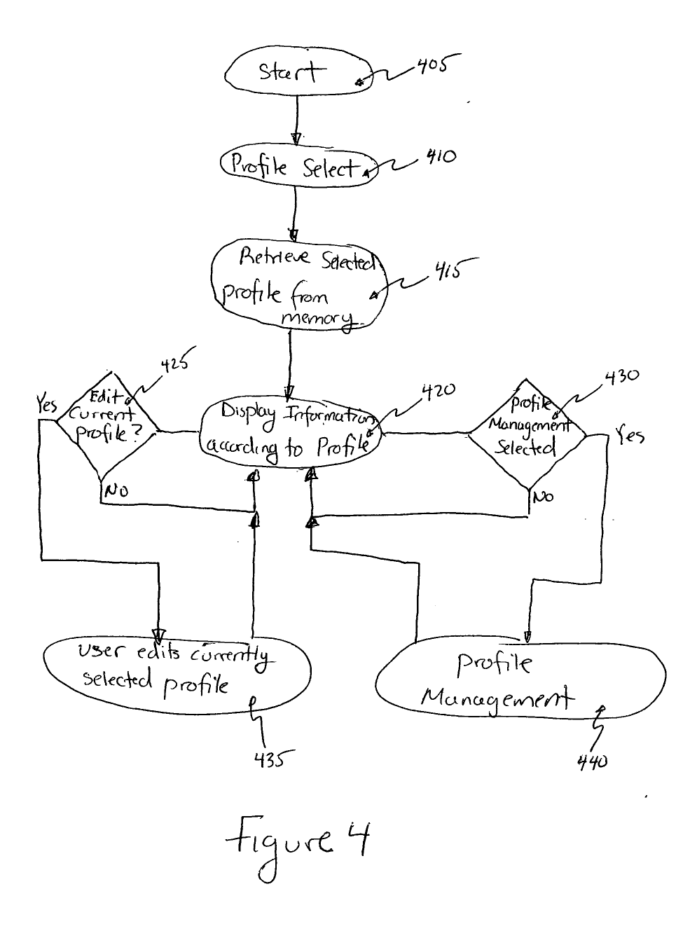

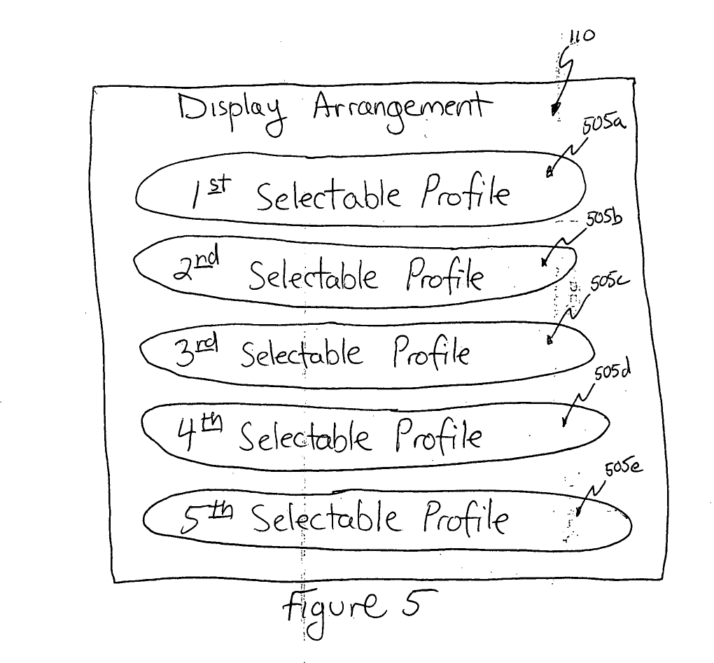

Referring now to FIG. 4, there is seen an operational sequence of the functionality of the software code configured to be executed by microprocessor 205 for displaying the electronic video and/or picture display information to the user in accordance with the configuration information received from the input arrangement 105. The sequence begins at start step 405 and proceeds to step 410, in which a user profile is selected. The user profile contains information related to a particular user preference characterizing what data concerning the vehicle is to be displayed to the user via display arrangement 210, and how and where such data is displayed via display arrangement 210. For this purpose, a plurality of profiles may be stored in memory, for example, memory arrangement 210, one of which may be retrieved by microprocessor 205 in accordance with the profile selection step 410. To retrieve a particular profile, a user interfaces (i.e., inputs input information) with input arrangement 105 to select the desired user profile, as shown in FIG. 5. During profile selection step 410, display arrangement 210 may display, for example, a list of available user profiles, from which the user of the vehicle may select.

Referring to FIG. 5, there is seen an exemplary display of five profiles, for example, for a family of five individuals. In this exemplary embodiment, microprocessor 205 cause the display arrangement 110 to display five individually selectable profiles 505a, 505b, 505c, . . . , 505e, from which the current user of the vehicle may select a desired profile. For this purpose, the user interfaces with input arrangement 105 to select the desired profile. For example, if input arrangement 105 includes a keyboard, the user may, for example, depress a particular key associated with the desired profile.

It should be appreciated that the at least one of the user profiles stored in memory, for example, stored in memory arrangement 210, may be password protected and/or have certain associated access privileges (as more fully described below), so that only authorized individual(s) may retrieve the password protected user profiles. It should also be appreciated that the various profiles stored in memory may include, for example, a default user profile, which is automatically loaded when the vehicle is turned on, or if no other user profiles exist.

In another exemplary embodiment according to the present invention, profile selection step 410 may occur automatically when the user selects a custom preset for a vehicle characteristic, for example, a custom preset for a seat adjustment. In this regard, it is known to have various selectable seat adjustment settings for various associated and/or authorized users of the vehicle. When the user selects a custom preset for a seat adjustment, the seat automatically configures to a customizable setting characterizing the proportions of the human body of the user. Each of the custom presets may be edited to the preferences and/or physical dimensions of a particular user. For example, if a vehicle includes a custom preset arrangement for seat adjustment having three selectable presets, each of the three selectable presets may be adjusted to the body proportions of an assigned user (e.g., preset 1 may be set to the body proportions of the father; preset 2 may be set to the body proportions of the mother; and preset 3 may be set to the body proportions of the son). Such a seat adjustment system is well known and conventional in the art. According to this exemplary embodiment according to the present invention, if the user selects a custom preset for a seat adjustment, a signal generated by the custom preset system (not shown) is communicated to the microprocessor 205, the communicated signal permitting microprocessor 205 to determine the user assigned to the custom preset for seat adjustment currently selected. The microprocessor 205 and/or memory arrangement 210 may, for example, include a file associating seat preferences with one or more of the selectable profiles for display stored in memory. At least one of the profiles for display stored in memory may be associated with a respective one of the custom presets for a seat adjustment, so that, when a particular custom preset for seat adjustment is selected, an associated profile for display is automatically selected in step 410. In this manner, the user's particular display profile may be automatically selected in profile selection step 410 when that user selects his custom preset for a seat adjustment. It should also be appreciated that the above-described procedure for associating custom presets for a seat adjustment with display profiles may be reversed. That is, a custom preset for a seat adjustment may be automatically selected when the user manually selects a display profile in profile selection step 410, as described above. In this manner, the user's seat may automatically adjust when the user selects his/her associated display profile. It should also be appreciated that, although the present exemplary embodiment automatically selects a display profile in accordance with the selection of a custom preset for a seat adjustment, the display profile may be automatically selected in accordance with the selection of any custom preset for any vehicle characteristic. For example, the display profile may be automatically selected in accordance with the selection of a custom preset for air conditioning preference (i.e., preferred cabin temperature), music station preference, music volume preference, cabin lighting intensity preference, and the like.

In another exemplary embodiment of the present invention, profile selection step 410 may occur automatically without user intervention via user identification arrangements (not shown) situated in the vehicle, without need for user interaction with the vehicle, for example, without need for inputting information into input arrangement 105 and/or without need for selecting a custom preset for a vehicle characteristic. User identification arrangements include any mechanism, circuit, and/or structure operable to detect any characteristic of a user (e.g., the weight of the user). For example, a weight of an assigned and/or authorized user may be stored along with the profile information for that particular user(s).

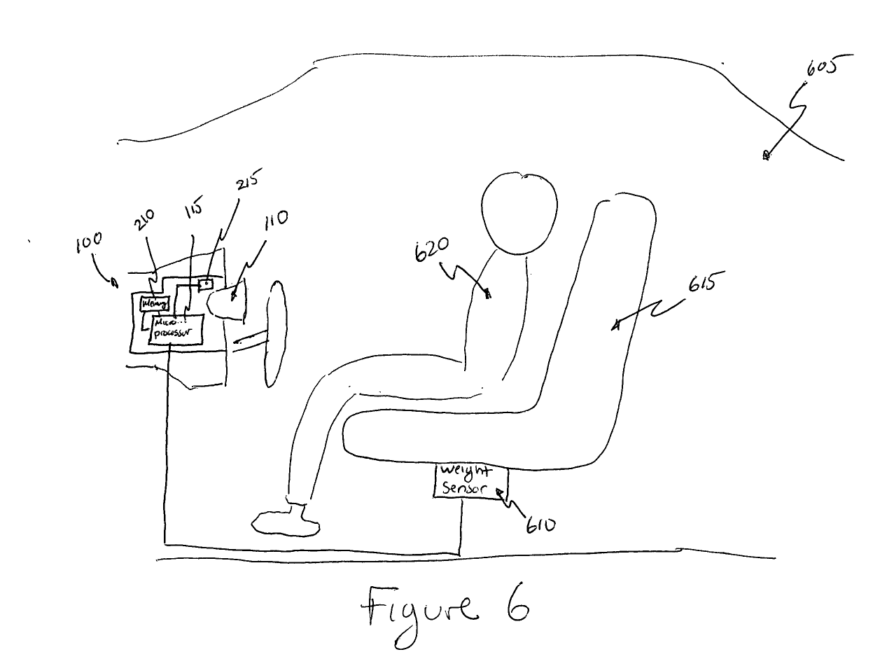

Referring now to FIG. 6, there is seen the interior of a vehicle 605 having an exemplary reconfigurable vehicle display 100 according to the present invention. As shown in FIG. 6, a user identification arrangement in the form of a weight sensor 610 is suitably situated, for example, below and/or within seat 615. In this manner, the weight of user 620 operating the vehicle and select the appropriate profile accordingly. For example, if a family of five individuals included a father weighing 175 lbs, a mother weighing 110 lbs, a daughter weighing 100 lbs, and a son weighing 150 lbs, each of, for example, four user profiles may have stored therewith associated information concerning the respective weights of the family members. Accordingly, for example, if the weight sensor detected an occupant weighing approximately 100 lbs, microprocessor 205 would automatically cause the profile associated with the daughter to be selected in profile selection step 410. For this purpose, the electronic signals 220 communicated to microprocessor 205 may include an electronic signal from the weight sensor (not shown) situated in at least one of the vehicle seats, the electronic signal from the weight sensor characterizing the weight of an occupant in the associated seat.

In another exemplary embodiment according to the present invention, the profile selection step 410 occurs by detecting the presence of an inductively coupled passive transponder associated with a particular associated and/or authorized user of the vehicle. In this manner, an inductor coil situated in the vehicle transmits a magnetic field of a certain frequency (i.e., interrogates for a transponder). A transponder located in the vicinity of the vehicle includes a coil, and the magnetic field produced by the vehicle's transmission coil causes a voltage to be induced across the coil of the transponder. In a known manner, the transponder extracts electrical energy from the induced voltage, and then causes current to either flow through the coil or not flow in accordance with a data signal stored in a memory of the transponder. The current flow through the transponder coil causes dips in the magnetic field produced by the transmission coil of the vehicle. The vehicle may then detect the dips in the magnetic field and, as such, extract the data signal stored in the transponder. Such passive transponder systems are well known and referred to in, for example, U.S. Pat. No. 5,382,952 to Miller, U.S. Pat. No. 4,818,855 to Mongeon et al., and U.S. Pat. No. 4,630,044 to Polzer. In this manner, each of the transponders assigned to the various users of the vehicle may include separate and unique data signal information, which effectively permits the vehicle to uniquely identify a particular user. Thus, in the four-person family example described above, each of the father, mother, son, and daughter may carry with him/her a separate passive transponder, each of which transmits unique data in response to a magnetic field interrogation generated by the vehicle's transmission coil. The microprocessor 205 may then select the appropriate user profile in profile selection step 410 in accordance with the data transmitted by a detected passive transponder. Thus, for example, if the daughter approached the vehicle with her assigned transponder, the vehicle would detect the signal information contained in the transponder and cause the user profile associated with the daughter to be automatically selected in profile selection step 410.

In another exemplary embodiment according to the present invention, profile selection step 410 occurs by detecting the presence of an active transponder, such as a remote battery operated transponder for unlocking and locking the doors of the vehicles. In this embodiment, each of the associated and/or authorized users of the vehicle would receive a separate active transponder for unlocking and locking the vehicle's doors and/or for turning off and on an alarm system for the vehicle. Each of the active transponders assigned to the associated and/or authorized users would wirelessly transmit a unique identification code along with the data required, for example to unlock and lock the vehicle's doors and/or for turning off and on an alarm system for the vehicle, when the assigned user operates the active transponder. Thus, for example, if the daughter approached the vehicle with her assigned active transponder, she may use the transponder, for example, to unlock the doors of the vehicle. In so doing, a unique code assigned to the daughter's transponder is transmitted to the vehicle. In this manner, the vehicle may cause the doors to be locked and may cause profile selection step 410 to automatically select the profile assigned to the daughter in accordance with the unique code transmitted by the daughter's active transponder.

It should be appreciated that, although the exemplary embodiments of the present invention described above refer to certain methods for automatically selecting a user profile in profile selection step 410, a profile may be automatically selected in accordance with any other method for automatically detecting a characteristic assigned to a particular associated and/or authorized user of the vehicle. For example, the present invention contemplates that the profile may be automatically selected in accordance with any other method, apparatus, and or device (e.g., user identification arrangements situated in the vehicle) for automatically detecting any characteristic and or the presence of an associated and/or authorized user of the vehicle.

After the profile is selected in profile selection step 410, microprocessor 205 retrieves the selected profile information from memory, for example, from memory arrangement 210. Once retrieved, the microprocessor causes display arrangement 110 to display the electronic video and/or picture display information to the user in accordance with the retrieved profile information, the display information representing at least one displayable characteristic of the vehicle and/or the vehicle's environment.

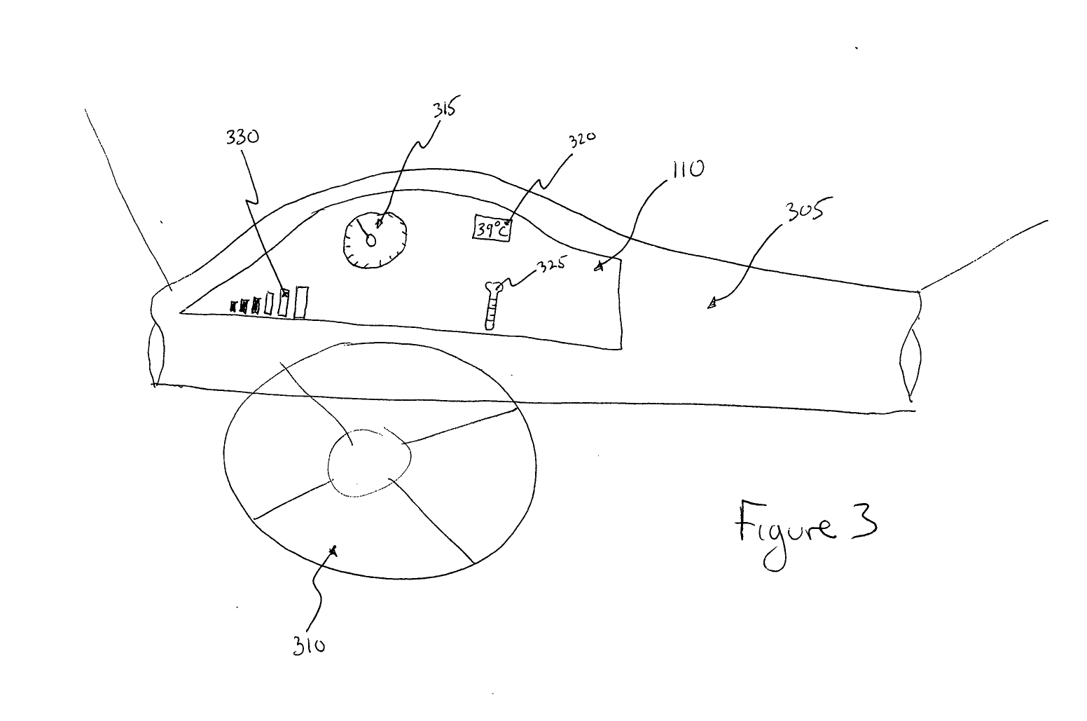

As described above, the profile information associated with the profile selected and retrieved in steps 410 and 415 contains information related to a particular user preference concerning what data (e.g., characteristic) about the vehicle and/or the vehicle's environment are to be displayed to the user via the display arrangement 210, and how and where such data are to be displayed via the display arrangement 210. FIG. 3 illustrates an exemplary electronic video and/or picture display information displayed on display arrangement 110 in accordance with a hypothetical selected profile retrieved from memory in step 415 of the operational sequence of FIG. 4. In this exemplary embodiment, display arrangement 110 is situated in the dash board 305 of the vehicle behind a steering wheel 310. Alternatively, however, it should be appreciated that display arrangement 110 may be situated in other locations, such as projected onto the windshield in a heads-up display.

The profile information associated with this hypothetical and exemplary profile contains information related to a particular user preference for only four vehicle characteristics to be displayed to the associated and/or assigned user of the vehicle: a speed indicator 315, an ambient temperature indication 320, an engine temperature indication 325, and an RPM bar graph indicator 330. However, it should be appreciated that any, some, and/or all of the profiles stored in memory, for example, memory arrangement 210, may contain information related to a particular user preference for any number of vehicle characteristics to be displayed to the associated and/or assigned user of the vehicle. For example, any, some, and/or all of the profiles may contain profile information related to a particular user preference for any number of vehicle and/or environmental characteristics to be displayed to the associated and/or assigned user of the vehicle, such as the speed of the vehicle, revolutions per minute (RPM) of the engine, temperature of the engine, temperature of the ambient air inside the driving compartment, temperature of the air outside the vehicle, humidity information, oil pressure, gasoline level, turn directional, radio station information (e.g., station, volume, etc.), cruise control information (e.g., set, resume, etc.), headlight status information (e.g., lights off, normal, high-beams), an electronic map in relation to the geographical position of the vehicle, etc. It will be appreciated, however, that the various exemplary embodiments of the present invention are not intended to be limited by what kinds and/or types of information is to be displayed.

The profile information associated with the profile may also indicate how and where such vehicle and/or environmental characteristics are to be displayed on the display arrangement 210. For example, with respect to the exemplary embodiment of FIG. 3, which displays information in accordance with the hypothetical and exemplary profile described above, the profile information associated with the selected hypothetical profile causes the display location of the speed indicator 315 to be in the upper left portion of the display arrangement 110, causes the display location of the ambient temperature indication 320 to be in the upper right portion of the display arrangement 110, causes the display location of the engine temperature indication 325 to be in the lower right portion of the display arrangement, and causes the display location of the RPM bar graph indicator 330 to be in the lower left portion of the display arrangement 110. It should be appreciated that, although the exemplary display of FIG. 3 shows four vehicle characteristics displayed in four locations, the profile information associated with a selected profile may cause the display location of any vehicle and/or environmental characteristic to be displayed in any portion of the display arrangement 110.

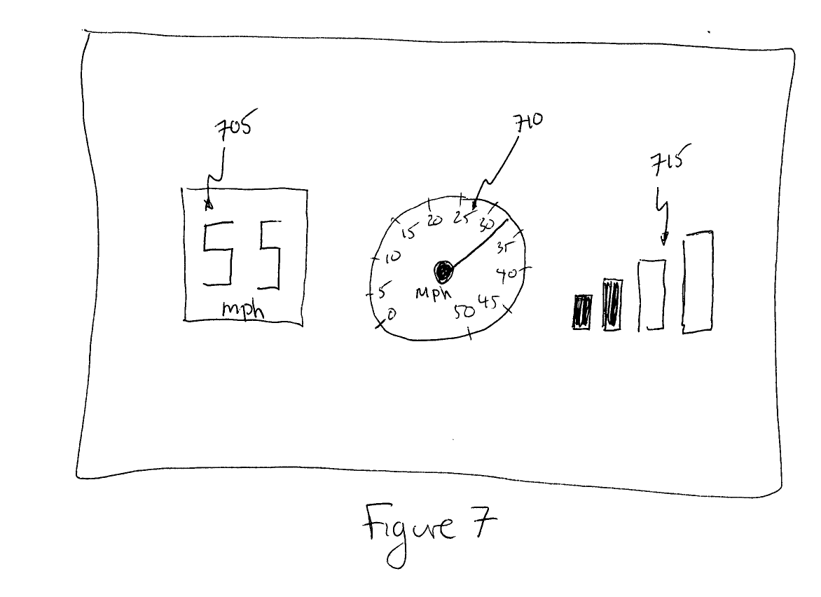

Processing arrangement 115 may also permit the user to vary the “skin” (i.e., the display format) of a selected displayable vehicle and/or environmental characteristic is displayed. In this manner, the present exemplary embodiment of the present invention contemplates that a particular vehicle or environmental characteristic may be displayed in various way using one of a plurality of selectable graphic formats. Referring now to FIG. 7, for example, if speed is among the selected vehicle characteristics to be displayed, the software program and profile information may permit the user to choose one of a verity of graphical speed indicators, such as an arabic speed indicator 705, a classic dial-type speed indicator 710 or, alternatively, a racing bar style 715 speed indicator. In this way, the user can choose a “skin,” look, or feel to further customize the display of vehicle and/or environmental characteristics on display arrangement 110. It should be appreciated that, although this exemplary embodiment describes three ways in which the speed of the vehicle may be displayed, any of the supported vehicle and/or environmental characteristics for display may be assigned various display formats, from which an editing user may select in accordance with his/her preference. Particularly, the user may be presented with a list of selectable display formats for each supported vehicle and/or environmental characteristics. The user would then choose the display format according to his preference.

In another exemplary embodiment according to the present invention, the collection of available display formats for the supported vehicle and/or environmental characteristics may be updated and/or modified via the update information described above. Specifically, display format updates may be downloaded via an update cable (not shown) connected to a computer, for example, a computer at the user's home or at a vehicle service station or center. Alternatively, the display format updates for the supported vehicle and/or environmental characteristics may be updated and/or modified by downloading updates wirelessly, for example, from a local area network, a wide area network, the Internet, the wireless web, etc. In this manner, a user can “download” new display formats (i.e., skins), for example, from a website or other display format repository. The technology to effect such updating of display formats, i.e., the technology for downloading information wirelessly and/or via a cable is widely known and, as such, will not be given further attention. Thus, if the user did not have, for example, the racing bar style speed indicator, he could, according to this exemplary embodiment of the present invention, download the racing bar speed indicator either wirelessly or via cable.

Once the associated profile has been selected, retrieved, and displayed by steps 410, 415, and 420, the associated and/or authorized user of the vehicle assigned to that profile may edit the profile information stored in that associated profile. For this purpose, the user causes microprocessor 205 to enter a “profile edit mode” by entering appropriate instructions and/or information via input arrangement 105 in step 425. For example, “profile edit mode” may be entered if the user depresses a button or series of buttons (not shown), for example, on a keyboard of user input arrangement 105. Or, for example, the user may enter “profile edit mode” by touching the appropriate portion of, for example, a touch screen of input arrangement 105. However, it should be appreciated that the present invention is not intended to be limited by the actual method employed for entering the “profile edit mode.” As such, it will be appreciated that the present invention would permit the “profile edit mode” to be entered by the user in any manner whatsoever.

Once in the “profile edit mode,” the user may edit the profile information associated with one or more of the profiles stored in memory arrangement 210 in step 435. For example, the “profile edit mode” may permit the user to modify which vehicle and/or environmental characteristics are to be displayed via display arrangement 110. For this purpose, the software program contained in memory arrangement 210 may cause microprocessor 205 to present a list of which vehicle and/or environmental characteristics are supported for display. The presented list may take the form of a word list of supported vehicle and/or environmental characteristics and/or may take the form of a graphical representation, such as a display of various computer icons, each of which is assigned to a supported vehicle and/or environmental characteristic. The user would then select which of the supported vehicle and/or environmental characteristics he/she wishes to display via display arrangement 110. For this purpose, the user would input his/her preference using input arrangement 105. Thereafter, the profile associated with the current user would store therewith profile information characterizing which vehicle and/or environmental characteristics are to be displayed via display arrangement 110.

In permitting the user to select which vehicle and/or environmental characteristics are to be displayed, the software program contained in memory arrangement 210 may also permit the reconfigurable vehicle display 100 to automatically detect the presence of physical hardware associated with the vehicle and/or environmental characteristics. In this manner, microprocessor 205 may exhibit a “plug-and-play” functionality for various vehicle components. Thus, for example, if microprocessor 205 detects the presence of a cruise control system, the list of supported vehicle and/or environmental characteristics presented to the user in the edit profile step 425 may be updated with an icon and/or word list selection identifying “cruise control” as one of the supported vehicle and/or environmental characteristic, which may be selected for display on the display arrangement 110. For this purpose, electrical signals 220 communicated to the microprocessor 205 may include identification signals communicated by various vehicle systems or components (e.g., identification signals communicated by the cruise control system). The identification signals may identify and/or characterize whether the particular associated vehicle system and/or component is present in the vehicle. In this manner, the “plug-and-play” functionality would permit reconfigurable vehicle display 100 to dynamically adapt to changes in the vehicle. It would also permit the design of a single version of the software program stored in memory arrangement 210, regardless of which features of the vehicle a particular customer selected during the purchase of the vehicle. Thus, for example, regardless whether the user selected a cruise control feature when purchasing the vehicle, the software program stored in memory arrangement 210 would automatically adapt, thereby obviating the need for various versions of the software program. It should be appreciated that, although this exemplary embodiment describes the “plug-and-play” functionality only with respect to cruise control, the “plug-and-play” functionality may be configured to detect the presence of any vehicle system or component and update the list of supported vehicle and/or environmental characteristics presented to the user in edit profile step 425 accordingly. For example, the “plug-and-play” functionality may be configured to detect the presence of a radio, air conditioning unit, power windows, power brakes, temperature sensors for measuring ambient cabin temperature, temperature sensors for measuring the temperature of the environmental air outside the vehicle, etc.

The user may also cause the software program to enter a profile management mode in step 430. Profile management mode permits at least one authorized user to add profiles, delete profiles, and/or change access permissions of profiles. For this purpose, the user causes the microprocessor 205 to enter a “profile management mode” by entering appropriate instructions and/or information via input arrangement 105 in step 430. For example, “profile management mode” may be entered if the user depresses a button or series of buttons (not shown), for example, on a keyboard of user input arrangement 105. Or, for example, the user may enter “profile management mode” by touching the appropriate portion of, for example, a touch screen of input arrangement 105. However, it should be appreciated that the present invention is not intended to be limited by the actual method employed for entering the “profile management mode.” As such, it will be appreciated that the present invention would permit the “profile management mode” to be entered by the user in any manner whatsoever.

After selecting “profile management mode,” in step 430, the operational sequence proceeds to step 440, in which the authorized user may perform profile management. To add a profile, the software program permits the user, for example, to assign an identifying characteristic to the profile (e.g., a name) and may, for example, cause the newly added profile to exhibit a default display, which may thereafter be edited in steps 425 and 435, as described above. Thus, in this manner, for example, if all of the members of the family of four individuals described above are permitted to operate the vehicle, the authorized user(s) (e.g., the father) may setup four unique profiles in step 440, each of which is assigned to an individual family member. Once the new profiles are added, the new profiles become available for selection in the profile selection step 410. The authorized user(s) (e.g., the father) may also delete one or more profiles. Once deleted, the profiles are no longer available for selection in the profile selection step 410.

In step 440, the authorized user(s) may also assign each of the profiles with one or more access privileges. The access privileges assigned to a particular profile characterize the scope and extent to which an individual may edit information associated with the assigned profile. For example, the father of the family of four individuals described above (father, mother, son, daughter), may desire that the profiles assigned to the son and daughter always display at least the speed of the vehicle and gasoline level, regardless of the personal preferences of the son and the daughter. Thus, in this exemplary and hypothetical example, if the son attempted to edit his profile in step 435, he would not be able to prevent the speed of the vehicle and gasoline level from being displayed. Alternatively, the father may assign no editing access privileges for a particular profile. Thus, if the son's profile had no editing access privileges, he would not be able to select the profile editing mode in step 425. The access privileges may also indicate which profiles may enter the profile management mode in step 430. For example, the authorized user(s) may assign “profile management mode” access privileges only to the profiles assigned, for example, to the mother and father, but not the son and daughter.

In accordance with another exemplary embodiment of the present invention, each of the profiles stored in memory, for example, memory arrangement 210, may have associated therewith a plurality of sub-profiles for customizing the display of display arrangement 110. Each of the sub-profiles may be assigned to a particular operating state of the vehicle, such that when the vehicle enters the particular operating state, the sub-profile assigned to that state is displayed to the user in step 420. Each of the sub-profiles may be individually edited in steps 425 and 430 for displaying vehicle and/or environmental characteristics in the manner described above, so that the display may be customized for particular operating states of the vehicle. For example, a user may assign one of the sub-profiles of his/her profile to become displayed in step 420 when the vehicle exceeds a speed of, for example 55 miles per hour (i.e., an operating state of the vehicle exceeding 55 miles per hour). The sub-profile may be edited in steps 425 and 430, for example, with a highly prominent speed indication of vehicle speed. In this manner, if the speed of the vehicle exceeds 55 miles per, the sub-profile may be automatically selected to make the speed indication of vehicle speed more prominent on the display arrangement 110 (e.g., make the speed indication bigger, more centered, highlighted, etc.). Or, for example, if the vehicle's cruise control is selected (i.e., a cruise control operating state), a sub-profile may be selected that displays status information concerning the cruise control (i.e., axle set, resume, stop, etc.). Or, for example, if the vehicle is stopped (i.e., a stopped operating state), a video phone display or map may be presented to the user. It should also be appreciated that the various sub-profiles may cause certain indications not to be displayed. For example, if the vehicle is in a stopped state, there would be no need to display an indication concerning RPM or speed of the vehicle. Thus, when the vehicle enters a stop state, a sub-profile may be selected that, for example, replaces the speed indicator and RPM indicator with a screen saver, video phone, map, etc. It should be appreciated that a sub-profile may be assigned to and automatically selected for display in step 420 in response to the occurrence of any vehicle operating state, such as a stop state, a state indicating the speed of the vehicle exceeds 55 miles per hour, a state of the vehicle traveling uphill, a state of the vehicle traveling downhill, a turning state of the vehicle (i.e., if the vehicle is turning), a reverse state (i.e., if the vehicle is reversing or backing up), a state indicating a low level of gasoline, etc.

It should also be appreciated that the sub-profiles may be assigned to events other than vehicle operating states. For example, the sub-profiles may be assigned to be displayed at a particular time and/or during particular times, for example, particular times of the year. In this manner, the user may, for example, design and customize different displays for different seasons of the year and/or different months of the year. For this purpose, the software program stored in memory arrangement 210 may include a clock and calendar information permitting microprocessor 205 to select an associated profile at a suitable time.

1. A reconfigurable display of a vehicle, comprising:
an input arrangement to receive configuration information from at least one user;
a processing arrangement electrically and communicatively coupled to the input arrangement to process the configuration information; and
a display arrangement electrically and communicatively coupled to the processing arrangement;
wherein the processing arrangement is configured to display at least one characteristic of the vehicle via the display arrangement in accordance with profile information assigned to a selected profile of a plurality of profiles.

2. The reconfigurable display of claim 1, wherein the processing arrangement includes a microprocessor to receive the configuration information from the input arrangement, a memory arrangement to store a software program to be executed on the microprocessor, and a display driver electrically and communicatively coupled to the microprocessor and configured to format display information generated by microprocessor so that the display information may be suitably displayed on the display arrangement.

3. The reconfigurable display of claim 2, wherein the microprocessor receives electronic signals from associated vehicle sensors, the electronic signals characterizing associated displayable vehicle characteristics, the processing arrangement being configured to display the at least one characteristic of the vehicle via the display arrangement in accordance with the electronic signals.

4. The reconfigurable display of claim 3, wherein the electronic signals include at least one of a signal characterizing a speed of the vehicle, a signal characterizing revolutions per minute (RPM) of an engine, a signal characterizing a temperature of the engine, a signal characterizing a temperature of ambient air inside a driving compartment, a signal characterizing a temperature of air outside the vehicle, a signal characterizing humidity, a signal characterizing oil pressure, a signal characterizing a gasoline level, a signal characterizing a turn directional, a signal characterizing radio station information, a signal characterizing cruise control information, a signal characterizing headlight status information, and a signal characterizing an electronic map in relation to a geographical position of the vehicle.

5. The reconfigurable display of claim 1, wherein the selected profile of the plurality of profiles is selected automatically.

6. The reconfigurable display of claim 5, wherein the selected profile of the plurality of profiles is automatically selected when the user selects a custom preset for at least one vehicle characteristic.

7. The reconfigurable display of claim 5, wherein the selected profile of the plurality of profiles is selected by detecting the presence of at least one transponder.

8. The reconfigurable display of claim 5, wherein the selected profile of the plurality of profiles is selected via user identification arrangements situated in the vehicle.

9. The reconfigurable display of claim 8, wherein the user identification arrangements include at least one weight sensor situated in an associated seat of the vehicle, the weight sensor generating an electrical signal characterizing a weight of an occupant of a vehicle seat.

10. The reconfigurable display of claim 1, wherein the profile information includes information characterizing what data concerning the vehicle is to be displayed to the user via the display arrangement, and the profile information characterizes how and where the data concerning the vehicle is to be displayed via the display arrangement.

11. The reconfigurable display of claim 10, wherein the processing arrangement permits the user to vary a display format of the data concerning the vehicle.

12. The reconfigurable display of claim 11, wherein the data concerning the vehicle includes at least one of speed of the vehicle, revolutions per minute (RPM) of an engine, temperature of the engine, temperature of ambient air inside a driving compartment, temperature of air outside the vehicle, humidity information, oil pressure, gasoline level, turn directional, radio station information, cruise control information, headlight status, and an electronic map in relation to a geographical position of the vehicle.

13. The reconfigurable display of claim 1, wherein the processing arrangement permits the profile information associated with at least one of the plurality of profiles to be edited by the user.

14. The reconfigurable display of claim 1, wherein the processing arrangement may be caused to enter a profile management mode to permit at least one authorized user to at least one of add profiles, to delete profiles, and to change access permissions of the profiles.

15. The reconfigurable display of claim 1, wherein the at least one characteristic of the vehicle is displayed in accordance with at least one of an operating state of the vehicle and an occurrence of an event

16. The reconfigurable display of claim 15, wherein each of the profiles includes a plurality of sub-profiles, each of the sub-profiles being assigned to a respective operating state of the vehicle, the at least one characteristic of the vehicle being displayed in accordance with information of the sub-profile assigned to a current operating state of the vehicle.

17. The reconfigurable display of claim 17, wherein the event includes at least one of a particular time, a particular duration of time, a particular month, and a particular season.

18. The reconfigurable display of claim 1, wherein the processing arrangement includes a data interface arrangement configured to retrieve update information from an external computer, the update information configured to update a software program stored in the processing arrangement.

19. A reconfigurable display arrangement of a vehicle, comprising:
means for receiving configuration information from at least one user;
means for processing the configuration information; and
means for displaying at least one characteristic of the vehicle in accordance with information assigned to a selected profile of a plurality of profiles.

20. A vehicle, comprising:
a passenger cabin to receive at least one passenger; and
a reconfigurable display arrangement of a vehicle, including an input arrangement to receive configuration information from at least one user; a processing arrangement electrically and communicatively coupled to the input arrangement to process the configuration information;
and a display arrangement electrically and communicatively coupled to the processing arrangement; wherein the processing arrangement is configured to cause the display arrangement to display at least one characteristic of the vehicle in accordance with profile information assigned to a selected profile of a plurality of profiles.
